(19) United States
(12) Patent Application Publication
(10) Pub. No.: US 2025/0392364 A1
(43) Pub. Date: Dec. 25, 2025

(54) METHOD AND APPARATUS FOR AI-BASED CSI FEEDBACK IN WIRELESS COMMUNICATION SYSTEMS

(71) Applicant: Samsung Electronics Co., Ltd., Suwon-si (KR)

(72) Inventors: Ameha Tsegaye ABEBE, Suwon-si (KR); Ashok Kumar Reddy CHAVVA, Bangalore (IN); Ashwini KUMAR, Bangalore (IN); Sripada KADAMBAR, Bangalore (IN); Wonjun KIM, Suwon-si (KR); Youngrok JANG, Suwon-si (KR); Hyoungju JI, Suwon-si (KR)

(21) Appl. No.: 19/246,443

(22) Filed: Jun. 23, 2025

(30) Foreign Application Priority Data
Jun. 21, 2024 (IN) 202411047944

(51) Int. Cl. H04B 7/06; H04W 72/232

(52) U.S. Cl. CPC H04B 7/0626; H04B 7/0639; H04W 72/232

(57) ABSTRACT

The disclosure relates to a 5G or 6G communication system for supporting a higher data transmission rate. According to an embodiment, a user equipment (UE) in a communication system includes a transceiver; and a processor coupled with the transceiver and configured to: receive, from a base station, configuration information associated with channel state information (CSI) report; identify, based on the configuration information, that a first precoding matrix indicator (PMI) component on basis information and N second PMI components on combining coefficients are to be transmitted for the CSI report; and transmit, to the base station, the first PMI component and the N second PMI components.

### CROSS-REFERENCE TO RELATED APPLICATION

This application is based on and claims priority under 35 U.S.C. § 119 to Indian Patent Application No. 202411047944, filed on Jun. 21, 2024, in the Indian Intellectual Property Office, the disclosure of which is incorporated by reference herein in its entirety.

### BACKGROUND

### 1. Field

The present disclosure relates to the field of 5G and beyond 5G communication networks and more particularly to channel state information (CSI) feedback in multiple-input multiple-output (MIMO) system and/or method and apparatus for artificial intelligence (AI)-based CSI feedback.

### 2. Description of Related Art

5G mobile communication technologies define broad frequency bands such that high transmission rates and new services are possible, and can be implemented not only in “Sub 6 GHz” bands such as 3.5 GHz, but also in “Above 6GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, a mobility enhancement including conditional handover and DAPS (Dual Active Protocol Stack) handover, and a two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The principal object of the disclosure herein is to disclose methods and apparatus for codebook based CSI reporting in communication networks, wherein the communication network is at least one of the 5G standalone network, a 5G non-standalone (NAS) network or 6G network.

As specific object of the disclosure herein is to disclose methods and systems to configure a UE with a CSI report including precoding information for reporting occasion where the precoding information includes two components.

As a yet another specific object of the disclosure herein is to disclose methods and systems for a UE upon receiving CSI report configuration from the network to transmit a CSI report that includes the precoding information for a reporting occasion where the precoding information includes at least one of two components.

As a yet another specific object of the disclosure herein is to disclose methods and systems for the network and UE wherein at least one of the two components of the precoding information is transmitted and received.

According to an embodiment, a user equipment (UE) in a communication system includes a transceiver; and a processor coupled with the transceiver and configured to: receive, from a base station, configuration information associated with channel state information (CSI) report; identify, based on the configuration information, that a first precoding matrix indicator (PMI) component on basis information and N second PMI components on combining coefficients are to be transmitted for the CSI report; and transmit, to the base station, the first PMI component and the N second PMI components, wherein the first PMI component is transmitted in a first CSI reporting occasion among N CSI reporting occasions, and wherein the N second PMI components are transmitted in the N CSI reporting occasions.

According to an embodiment, wherein in case that the CSI report is configured with periodic or semi-persistent, the first PMI component is transmitted according to a first reporting periodicity and the N second PMI components are transmitted according to a second reporting periodicity, wherein the first reporting periodicity is N times of the second reporting periodicity, wherein the second reporting periodicity corresponds to the N CSI reporting occasions, wherein the configuration information includes at least one of: information on the first reporting periodicity; information on the second reporting periodicity; or information on a value of N, and wherein in case that the CSI report is configured with aperiodic, the N CSI reporting occasions are identified based on first downlink control information (DCI) triggering the CSI report configured with aperiodic.

According to an embodiment, wherein a second PMI component transmitted in a CSI reporting occasion is calculated based on the first PMI component and a second PMI component transmitted in a past CSI reporting occasion.

According to an embodiment, wherein the first PMI component, a second PMI component, a CSI reference signal (CSI-RS) resource indicator (CRI) and a rank indicator (RI) for the CSI report are transmitted in the first CSI reporting occasion, wherein N−1 second PMI components are transmitted in N−1 CSI reporting occasions which are remaining CSI reporting occasions except for the first CSI reporting occasion, and wherein in case that at least one of CRI adaptation or RI adaptation is allowed in the N CSI reporting occasions based on the configuration information, at least one of updated CRI or updated RI is transmitted in at least one of the

According to an embodiment, wherein in case that transmission of the first PMI component in the first CSI reporting occasion is dropped at least partially: the first PMI component is retransmitted in an immediately following CSI reporting occasion; a second PMI component is transmitted in the immediately following CSI report occasion in which the first PMI component is retransmitted; and the N CSI reporting occasions are initialized such that a first CSI reporting occasion among the initialized N CSI reporting occasions corresponds to the immediately following CSI report occasion in which the first PMI component is retransmitted.

According to an embodiment, wherein in case that second DCI indicating retransmission of the first PMI component is received from the base station: the first PMI component is retransmitted in an earliest CSI reporting occasion after a processing delay for the second DCI and after reception of the second DCI; a second PMI component is transmitted in the earliest CSI reporting occasion in which the first PMI component is retransmitted; and the N CSI reporting occasions are initialized such that a first CSI reporting occasion among the initialized N CSI reporting occasions corresponds to the earliest CSI reporting occasion in which the first PMI component is retransmitted.

According to an embodiment, a method performed by a user equipment (UE) in a communication system includes receiving, from a base station, configuration information associated with channel state information (CSI) report; identifying, based on the configuration information, that a first precoding matrix indicator (PMI) component on basis information and N second PMI components on combining coefficients are to be transmitted for the CSI report; and transmitting, to the base station, the first PMI component and the N second PMI components, wherein the first PMI component is transmitted in a first CSI reporting occasion among N CSI reporting occasions, and wherein the N second PMI components are transmitted in the N CSI reporting occasions.

According to an embodiment, wherein in case that the CSI report is configured with periodic or semi-persistent, the first PMI component is transmitted according to a first reporting periodicity and the N second PMI components are transmitted according to a second reporting periodicity, wherein the first reporting periodicity is N times of the second reporting periodicity, wherein the second reporting periodicity corresponds to the N CSI reporting occasions, wherein the configuration information includes at least one of: information on the first reporting periodicity; information on the second reporting periodicity; or information on a value of N, and wherein in case that the CSI report is configured with aperiodic, the N CSI reporting occasions are identified based on first downlink control information (DCI) triggering the CSI report configured with aperiodic.

According to an embodiment, wherein a second PMI component transmitted in a CSI reporting occasion is calculated based on the first PMI component and a second PMI component transmitted in a past CSI reporting occasion.

According to an embodiment, wherein the first PMI component, a second PMI component, a CSI reference signal (CSI-RS) resource indicator (CRI) and a rank indicator (RI) for the CSI report are transmitted in the first CSI reporting occasion, wherein N−1 second PMI components are transmitted in N−1 CSI reporting occasions which are remaining CSI reporting occasions except for the first CSI reporting occasion, and wherein in case that at least one of CRI adaptation or RI adaptation is allowed in the N CSI reporting occasions based on the configuration information, at least one of updated CRI or updated RI is transmitted in at least one of the

According to an embodiment, wherein in case that transmission of the first PMI component in the first CSI reporting occasion is dropped at least partially: the first PMI component is retransmitted in an immediately following CSI reporting occasion; a second PMI component is transmitted in the immediately following CSI report occasion in which the first PMI component is retransmitted; and the N CSI reporting occasions are initialized such that a first CSI reporting occasion among the initialized N CSI reporting occasions corresponds to the immediately following CSI report occasion in which the first PMI component is retransmitted.

According to an embodiment, wherein in case that second DCI indicating retransmission of the first PMI component is received from the base station: the first PMI component is retransmitted in an earliest CSI reporting occasion after a processing delay for the second DCI and after reception of the second DCI; a second PMI component is transmitted in the earliest CSI reporting occasion in which the first PMI component is retransmitted; and the N CSI reporting occasions are initialized such that a first CSI reporting occasion among the initialized N CSI reporting occasions corresponds to the earliest CSI reporting occasion in which the first PMI component is retransmitted.

According to an embodiment, a base station in a communication system, the base station comprising: a transceiver; and a processor coupled with the transceiver and configured to: transmit, to a user equipment (UE), configuration information associated with channel state information (CSI) report, wherein the configuration information is associated with the UE to transmit a first precoding matrix indicator (PMI) component on basis information and N second PMI components on combining coefficients for the CSI report; and receive, from the UE, the first PMI component and the N second PMI components, wherein the first PMI component is received in a first CSI reporting occasion among N CSI reporting occasions, and wherein the N second PMI components are received in the N CSI reporting occasions.

According to an embodiment, wherein in case that the CSI report is configured with periodic or semi-persistent, the first PMI component is received according to a first reporting periodicity and the N second PMI components are received according to a second reporting periodicity, wherein the first reporting periodicity is N times of the second reporting periodicity, wherein the second reporting periodicity corresponds to the N CSI reporting occasions, wherein the first configuration information includes at least one of: information on the first reporting periodicity; information on the second reporting periodicity; or information on a value of N, and wherein in case that the CSI report is configured with aperiodic, the N CSI reporting occasions are indicated based on first downlink control information (DCI) triggering the CSI report configured with aperiodic.

According to an embodiment, wherein a second PMI component received in a CSI reporting occasion is calculated based on the first PMI component and a second PMI component received in a past CSI reporting occasion.

According to an embodiment, wherein the first PMI component, a second PMI component, a CSI reference signal (CSI-RS) resource indicator (CRI) and a rank indicator (RI) for the CSI report are received in the first CSI reporting occasion, wherein N−1 second PMI components are received in N−1 CSI reporting occasions which are remaining CSI reporting occasions except for the first CSI reporting occasion, and wherein in case that at least one of CRI adaptation or RI adaptation is allowed for the UE in the N CSI reporting occasions based on the configuration information, at least one of updated CRI or updated RI is received in at least one of the remaining CSI reporting occasions.

According to an embodiment, a method performed by a base station in a communication system includes transmitting, to a user equipment (UE), configuration information associated with channel state information (CSI) report, wherein the configuration information is associated with the UE to transmit a first precoding matrix indicator (PMI) component on basis information and N second PMI components on combining coefficients for the CSI report; and receiving, from the UE, the first PMI component and the N second PMI components, wherein the first PMI component is received in a first CSI reporting occasion among N CSI reporting occasions, and wherein the N second PMI components are received in the N CSI reporting occasions.

According to an embodiment, wherein in case that the CSI report is configured with periodic or semi-persistent, the first PMI component is received according to a first reporting periodicity and the N second PMI components are received according to a second reporting periodicity, wherein the first reporting periodicity is N times of the second reporting periodicity, wherein the second reporting periodicity corresponds to the N CSI reporting occasions, wherein the first configuration information includes at least one of: information on the first reporting periodicity; information on the second reporting periodicity; or information on a value of N, and wherein in case that the CSI report is configured with aperiodic, the N CSI reporting occasions are indicated based on first downlink control information (DCI) triggering the CSI report configured with aperiodic.

According to an embodiment, wherein a second PMI component received in a CSI reporting occasion is calculated based on the first PMI component and a second PMI component received in a past CSI reporting occasion.

According to an embodiment, wherein the first PMI component, a second PMI component, a CSI reference signal (CSI-RS) resource indicator (CRI) and a rank indicator (RI) for the CSI report are received in the first CSI reporting occasion, wherein N−1 second PMI components are received in N−1 CSI reporting occasions which are remaining CSI reporting occasions except for the first CSI reporting occasion, and wherein in case that at least one of CRI adaptation or RI adaptation is allowed for the UE in the N CSI reporting occasions based on the configuration information, at least one of updated CRI or updated RI is received in at least one of the remaining CSI reporting occasions.

The technical objects to be achieved by various embodiments of the disclosure are not limited to the technical objects mentioned above, and other technical objects not mentioned may be considered by those skilled in the art from various embodiments of the disclosure to be described below.

The above-described various embodiments of the disclosure are merely some of the preferred embodiments of the disclosure, and various embodiments reflecting the technical features of the disclosure may be derived and understood by those skilled in the art based on the following detailed description of the disclosure.

The disclosure may provide methods and apparatuses for AI-based CSI feedback.

The effects that can be achieved through the disclosure are not limited to the effects mentioned in the various embodiments, and other effects not mentioned will be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates an example wireless network according to embodiments of the present disclosure;

FIG. 2A illustrates an example wireless transmit path according to embodiments of the present disclosure;

FIG. 2B illustrates an example wireless receive path according to embodiments of the present disclosure;

FIG. 3A illustrates an example UE according to embodiments of the present disclosure;

FIG. 3B illustrates an example gNB according to embodiments of the present disclosure;

FIG. 4 illustrates exemplary cross-polarized MIMO antenna system according to embodiments of the present disclosure;

FIG. 5 illustrates exemplary layout for channel state information reference signal (CSI-RS) resource mapping in an orthogonal frequency division multiple access (OFDMA) time-frequency grid according to embodiments of the present disclosure;

FIG. 6 illustrates an example of precoder construction in Type II CSI according to embodiments of the present disclosure;

FIG. 7A illustrates exemplary reporting precoding matrices in subband granularity according to embodiments of the present disclosure;

FIG. 7B illustrates an exemplary precoding matrix construction for enhanced Type II CSI according to embodiments of the present disclosure;

FIG. 8 illustrates an example autoencoder based CSI feedback according to embodiments of the present disclosure;

FIG. 9 depicts an exemplary embodiment for an autoencoder based CSI feedback where a preprocessing unit transforms an estimated channel to stacked eigenvectors according to embodiments of the present disclosure;

FIG. 10 illustrates an example CSI report that considers past CSI reports for construction of a reported CSI according to embodiments of the present disclosure;

FIG. 11 illustrates artificial intelligence/machine learning (AI/ML)-based CSI report mechanism that considers past CSI reports for construction of a reported CSI according to embodiments of the present disclosure;

FIG. 12 illustrates an example AI/ML-based CSI report mechanism with preprocessing that considers the past CSI reports for construction of a reported CSI according to embodiments of the present disclosure;

FIG. 13 illustrates an example periodic and semi-persistent AI/ML-based CSI report mechanism with preprocessing that considers past CSI reports for construction of a reported CSI according to embodiments of the present disclosure;

FIG. 14 illustrates an example semi-persistent AI/ML-based CSI report mechanism with preprocessing that considers past CSI reports for construction of a reported CSI according to embodiments of the present disclosure;

FIG. 15A illustrates example report configuration mechanisms for an AI/ML-based CSI report mechanism with preprocessing that considers past CSI reports for construction of a reported CSI according to embodiments of the present disclosure;

FIG. 15B illustrates example report configuration mechanisms for an AI/ML-based CSI report mechanism with preprocessing that considers past CSI reports for construction of a reported CSI according to embodiments of the present disclosure;

FIG. 16 illustrates example uplink control information (UCI) construction aspects for an AI/ML-based CSI report mechanism with preprocessing that considers past CSI reports for construction of a reported CSI according to embodiments of the present disclosure;

FIG. 17 illustrates example UCI construction aspects for first CSI report and N−1 subsequent CSI reports in an AI/ML-based CSI report mechanism that spans N CSI reporting occasions according to embodiments of the present disclosure;

FIG. 18A illustrates example aperiodic and semi-persistent reporting for an AI/ML-based CSI report mechanism that spans N CSI reporting occasions according to embodiments of the present disclosure;

FIG. 18B illustrates example aperiodic and semi-persistent reporting for an AI/ML-based CSI report mechanism that spans N CSI reporting occasions according to embodiments of the present disclosure;

FIG. 19 illustrates an example CRI and RI adaptation for an AI/ML-based CSI report mechanism that spans N CSI reporting occasions according to embodiments of the present disclosure;

FIG. 20A illustrates example retransmission aspects for an AI/ML-based CSI report mechanism that spans N CSI reporting occasions according to embodiments of the present disclosure;

FIG. 20B illustrates example retransmission aspects for an AI/ML-based CSI report mechanism that spans N CSI reporting occasions according to embodiments of the present disclosure;

FIG. 21 illustrates example retransmission DCI and timeline aspects for an AI/ML-based CSI report mechanism that spans N CSI reporting occasions according to embodiments of the present disclosure;

FIG. 22 illustrates example retransmission DCI, timeline and re-initialization aspects for an AI/ML-based CSI report mechanism that spans N CSI reporting occasions. according to embodiments of the present disclosure;

FIG. 23 illustrates an example interdependent an AI/ML-based CSI report mechanism according to embodiments of the present disclosure;

FIG. 24A illustrates example interdependent AI/ML-based CSI report mechanisms with preprocessing that spans N CSI reporting occasions according to embodiments of the present disclosure; and

FIG. 24B illustrates example interdependent AI/ML-based CSI report mechanisms with preprocessing that spans N CSI reporting occasions according to embodiments of the present disclosure.

### DETAILED DESCRIPTION

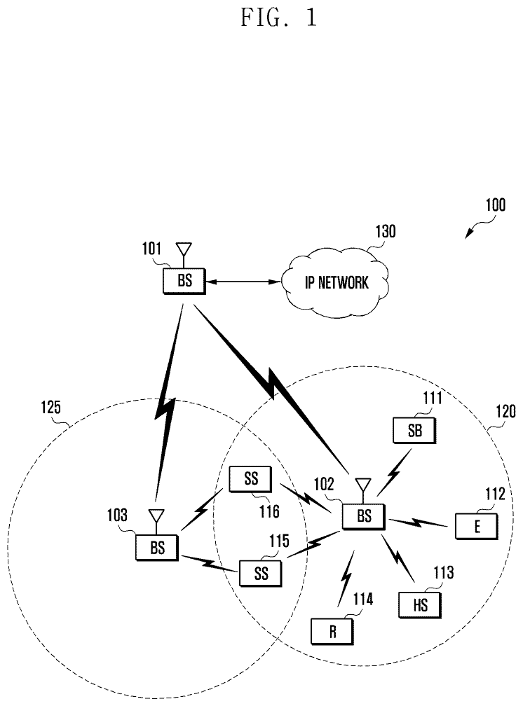

FIGS. 1 through 24B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

A description of example embodiments is provided in the following pages.

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The below flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mm Wave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

FIG. 1 illustrates an example wireless network 100 according to embodiments of the present disclosure. The embodiment of the wireless network 100 shown in FIG. 1 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to equipment that wirelessly accesses a gNB. The UE could be a mobile device or a stationary device. For example, UE could be a mobile telephone, smartphone, monitoring device, alarm device, fleet management device, asset tracking device, automobile, desktop computer, entertainment device, infotainment device, vending machine, electricity meter, water meter, gas meter, security device, sensor device, appliance, etc.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

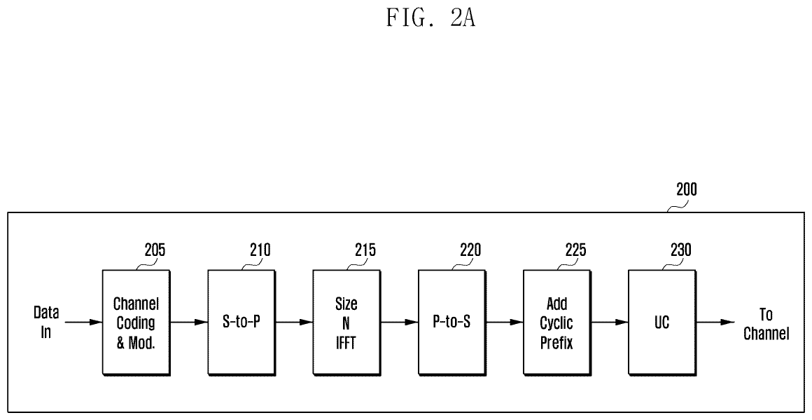

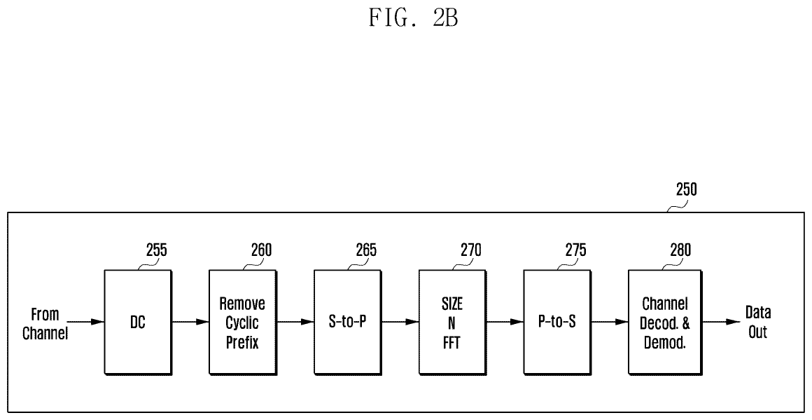

FIGS. 2A and 2B illustrate example wireless transmit and receive paths according to embodiments of the present disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel- to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

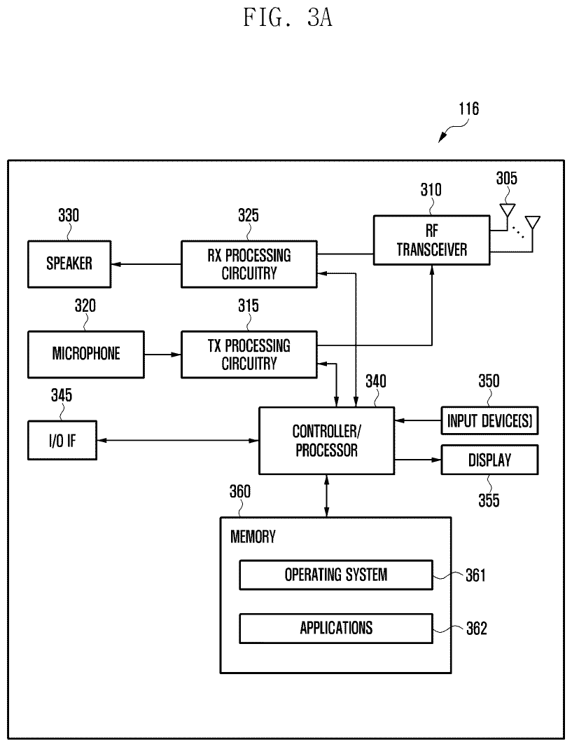

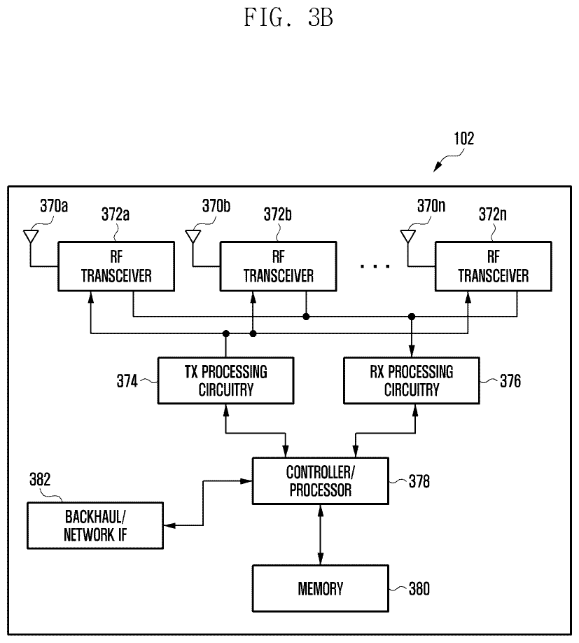

FIG. 3A illustrates an example UE 116 according to embodiments of the present disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the present disclosure as described in embodiments of the present disclosure. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to embodiments of the present disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of a gNB 102, various changes may be made to FIG. 3B. For example, the gNB 102 can include any number of each component shown in FIG. 3B. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

MIMO system where a base station (BS) and/or a UE is equipped with multiple antennas has been widely employed in wireless systems for its advantages in terms of spatial multiplexing, diversity gain and array gain.

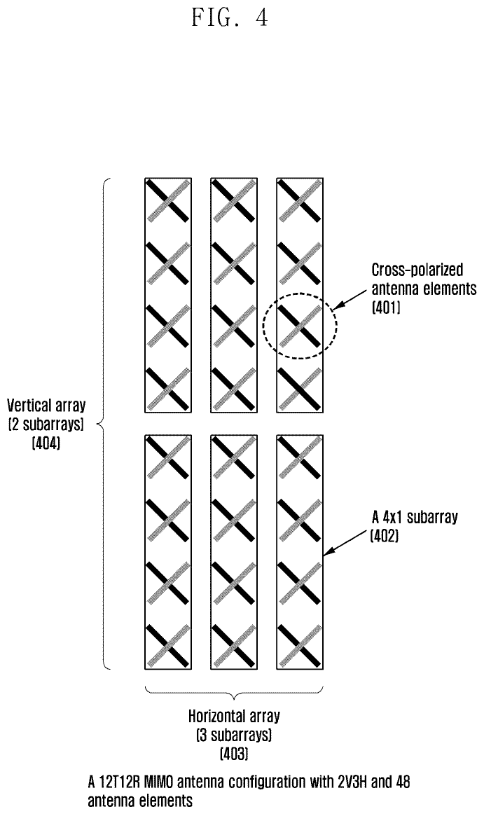

FIG. 4 illustrates an exemplary cross-polarized MIMO antenna system according to embodiments of the present disclosure. FIG. 4 illustrates an example of MIMO antenna configuration with 48 antenna elements. In the figure, 4 cross-polarized 401 antenna elements form a 4×1 subarray. 12 subarrays form a 2V3H MIMO antennas configuration including 2 and 3 subarrays in vertical (V) and horizontal (H) dimensions, respectively. Although FIG. 4 illustrates one example of MIMO antenna configuration, the disclosure can be applied to various such configurations.

In MIMO systems, CSI is required at a BS so that a signal from the BS is received at the UE with maximum possible received power and minimum possible interference. The acquisition of CSI at the BS can be via a measurement at the BS from an UL reference signal or via a measurement and feedback by the UE from a DL reference signal for time-domain duplexing (TDD, or time division duplexing) and frequency-domain duplexing (FDD, or frequency division duplexing) systems, respectively. In 5G FDD systems, the channel state information reference signal (CSI-RS) is the primary reference signal that is used by the UE to measure and report CSI.

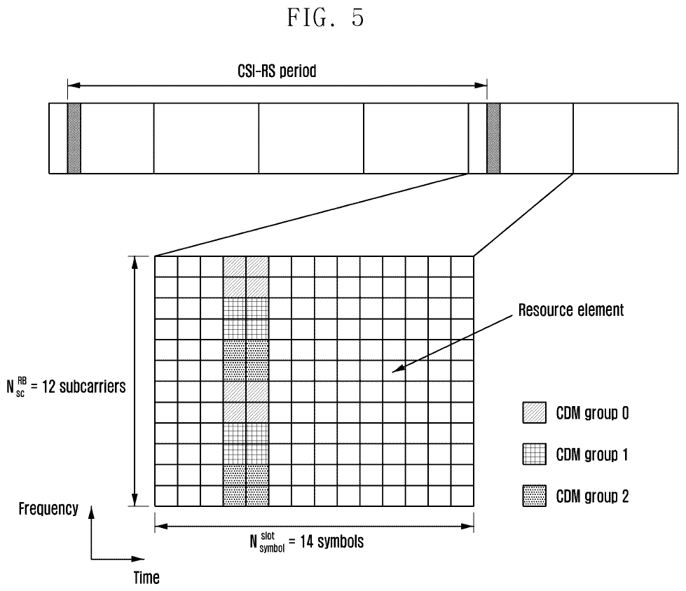

In some embodiments, a UE may receive a configuration signaling from a BS for a CSI-RS that can be used for channel measurement. An example of such configuration is illustrated in FIG. 5.

FIG. 5 illustrates exemplary layout for CSI-RS resource mapping in an OFDM access time-frequency grid according to embodiments of the present disclosure.

In FIG. 5, 12 antenna ports (CSI-RS ports) are mapped to a CSI-RS with 3 code-domain multiplexing (CDM, or code division multiplexing) groups, where each CDM group is mapped to 4 resource elements (REs) in OFDM time-frequency grid. The antenna ports that are mapped to the same CDM group can be orthogonalized in code-domain by employing orthogonal cover codes. The CSI-RS configuration in FIG. 5 can be related to the MIMO antenna configuration in FIG. 4, by mapping a CSI-RS port to one of the polarization of a subarray. In the 5G NR standards, three time-domain CSI-RS resources configurations (namely: periodic, semi-persistent and aperiodic) are possible. In FIG. 5, an illustrative example of periodic configuration is given with a period of 4 slots.

In some embodiments, the BS is capable of configuring a UE, by a higher layer signaling, with information for a CSI feedback that may include spatial channel information indicator and other supplementary information that would help the BS to have an accurate CSI. The spatial channel indicator, which is reported via a precoding matrix indicator (PMI) in 4G and 5G specifications, comprises a single or a plurality of channel matrix, the channel covariance matrix, the eigenvectors, or spatial sampling basis vectors. In particular, in 4G and 5G specification, the spatial channel information can be given by a single or a plurality of discrete Fourier transform (DFT) basis vectors.

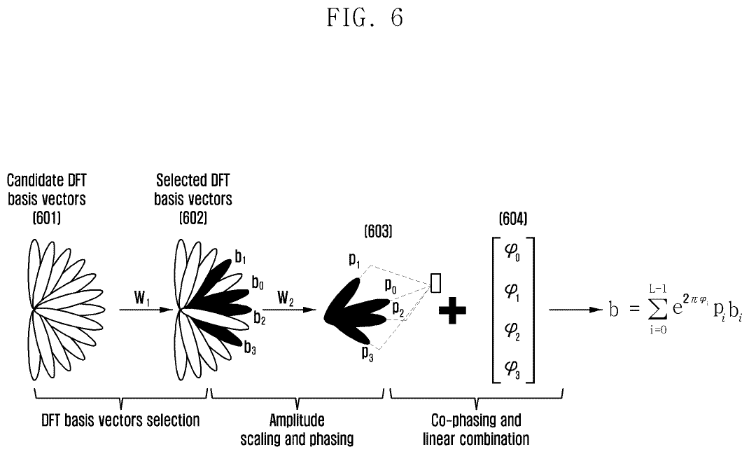

FIG. 6 illustrates an example of precoder construction in Type II CSI according to embodiments of the present disclosure. FIG. 6 illustrates an example of CSI feedback based on a plurality of DFT basis vectors for what is known as Type II CSI in 5G NR. The spatial information of the channel is reported in terms of L=4 DFT basis vectors {b₀, b₁, b₂, b₃} 602 from a set of candidate DFT basis vectors 601. Additionally, amplitude information {p₀, p₁, p₂, p₃} 603 and co-phasing information {φ₀, φ₁, φ₂, φ₃} (604) are reported. Thus, in Type II CSI a dual-stage precoding matrix is given as w=w₁w₂, where, w, selects the DFT basis vectors and w, assigns amplitude and co-phasing coefficients. Furthermore, a codebook can be defined as superset of candidate DFT basis vectors as well as candidate amplitude and phase coefficients. Then, a reported PMI may include indicators to the elements of a codebook that can represent the estimated channel.

In one exemplary embodiment, amplitude and phase information are reported in such a way that the linear combination of the basis vectors, i.e.,

$$b = {\sum }_{i = 0}^{L - 1} {e}^{2 {πφ}_{i}} {p}_{i} {b}_{i} ,$$

is matched to the eigenvector direction of the channel. Specifically, for a channel matrix H with the (s,u)-th element h_{s,u} representing the channel gain between the s-th transmit and the u-th receive antenna, the eigenvectors of the covariance matrix H^{H}H can be considered. Let eₗ denote one of the eigenvectors, then the PMI can be selected by the UE in such a way that the value

$$‖ {e}_{l}^{H} b ‖$$

is maximized.

Moreover, a UE can be configured in different ways to report a tuple of DFT basis vectors, amplitude coefficients and the phase coefficients, based on a polarization-common or polarization-specific manner. For example, in 5G NR specifications, DFT basis vectors are reported in a polarization-common manner while phase and amplitude coefficients are reported in a polarization specific manner, i.e., reported per polarization. MIMO systems allow spatial multiplexing, i.e., transmission of data in multiple transmission layers. In this regard, the type II CSI in the 5G NR allows the DFT basis vectors to be reported in a layer-common manner, i.e., common basis for all layers, while phase and amplitude coefficients may be reported in a layer-specific manner.

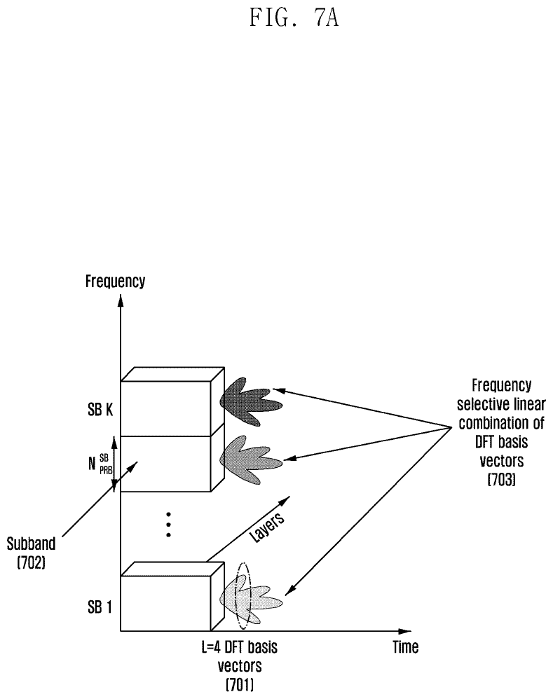

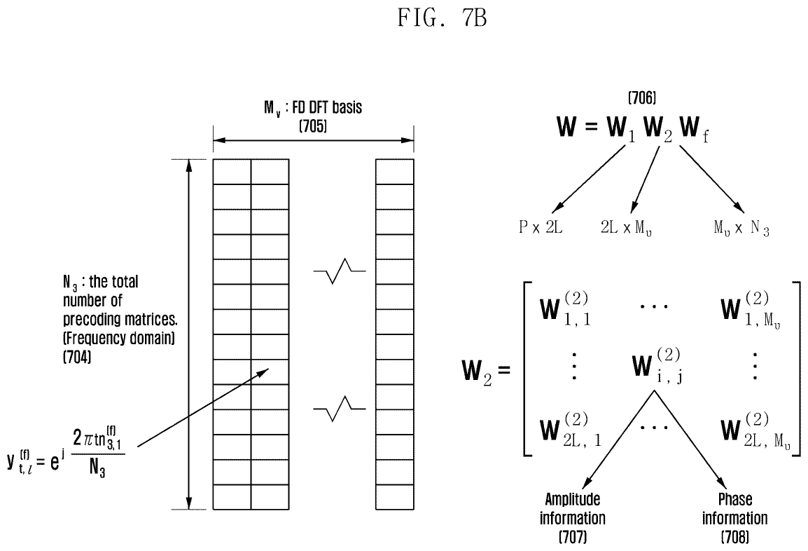

FIG. 7A illustrates exemplary reporting precoding matrices in subband granularity according to embodiments of the present disclosure. In order to account for the frequency-selectivity of a wideband channel, some embodiments allow various components of the precoding matrix, i.e., components of PMI, to be reported per frequency ranges. In some configurations, the frequency band that the UE is configured for CSI reporting is partitioned into a set of subbands and the amplitude and/or phases coefficients are reported per a subband manner. In particular, the DL BWP can be partitioned into subbands with subband size NSRR physical resource blocks (PRBs). Then, the selected DFT basis vectors 701 are linearly combined with different weights so that the resulting vector is aligned to the eigenvector of the channel in that subband. Denoting the set of subcarriers in the k-th subband as Fₖ, the eigenvectors of the averaged covariance matrix

$${C}_{k} = \frac{1}{\vert {F}_{k} \vert} = {\sum }_{f ∈ {F}_{k}} ( {( {H}_{f , k} )}^{H} ( {H}_{f , k} ) )$$

can be considered. Here, f∈Fₖ are subcarriers in the k-th subband and Hex is the corresponding channel matrix. FIG. 7A illustrates an example for frequency selective linear combination of DFT basis vectors 703 for K Subvanus or size

$${N}_{PRB}^{SB}$$

702.

FIG. 7B illustrates an exemplary precoding matrix construction for enhanced Type II CSI according to embodiments of the present disclosure. In 5G NR specifications, another configuration, known as enhanced Type II (eType II) CSI, allows reporting amplitude and phase coefficients in a delay-domain, rather than per subband reporting in a frequency-domain. This configuration reduces the feedback overhead as the delay components are usually much smaller than the equivalent number of subbands. In the enhanced Type II codebook (eType II CB) (FIG. 7B), precoding matrices are reported in a delay domain by employing a frequency-domain (FD) DFT basis 705 rather than the frequency domain reporting in Type II CSI (FIG. 7A), i.e., per subband or wideband. FIG. 7B illustrates exemplary construction of eType II CSI. In particular, a precoding matrix is expressed in three-stages

$$W = {W}_{1} {W}_{2} {W}_{f}^{H}$$

706. The spatial domain selection matrix w₁ selects L DFT vectors from P=2N₁N₂ CSI-RS ports, consequently, it has 2L rows accounting for the cross-polarized antennas. Moreover, an Mᵥ×N₃ matrix

$${W}_{f}^{H}$$

corresponds to Mᵥ DFT basis vectors that can transform the precoding matrix reported in a delay domain for Mᵥ delay components to a frequency domain with N₃ frequency domain points (bins) 704. In particular, the t∈{1,2, ⋅ ⋅ ⋅ , N₃}-th element of f-th vector is given by

$${γ}_{t , l}^{( f )} = {e}^{j \frac{2 π t {n}_{3 , l}^{( f )}}{{N}_{3}}} .$$

Finally, the matrix w₂ carries the amplitude and phase information where the i-th and j-th element, w_{i,j}, carries amplitude 707 and phase 708 information of i-th 2D DFT beam and j-th delay component.

In order to further reduce the CSI overhead, a system may exploit angle-delay reciprocity and measure the dominant angle and delay components of a channel from a UL reference signal such as sounding reference signal (SRS). Then, a precoded CSI-RS can be considered for DL CSI measurement, where the CSI-RS ports are mapped to an angle-delay component of the channel. Moreover, delay pre-compensation can be applied to the CSI ports so that the UE may measure CSI for a fewer number of delay components, i.e., in the extreme case for just one delay component.

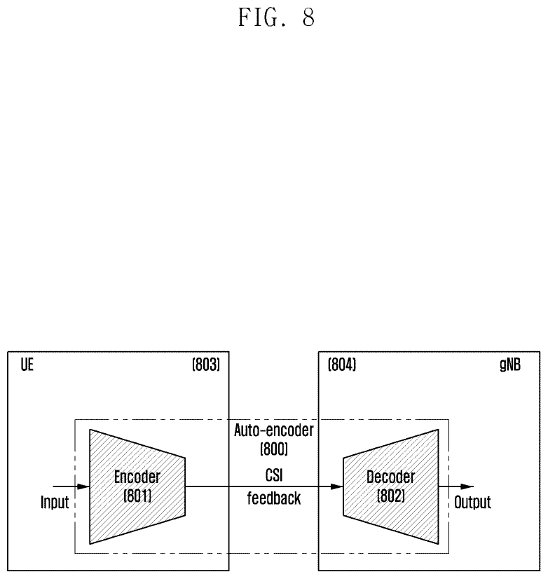

FIG. 8 illustrates an autoencoder based CSI feedback according to embodiments of the present disclosure. Recently, AI-based CSI feedback has gained considerable attention. In particular, an auto-encoder (AE) 800, as depicted in FIG. 8, including an encoder part 801 at the UE 803 the CSI feedback and a decoder 802 at the gNB 804 reconstructs the CSI feedback. The main aim of an AE-based CSI feedback (or AI-based CSI feedback) is to find the best representation of a channel state information in terms of feedback overhead. In another words, AE compresses the CSI to reduce the CSI feedback overhead.

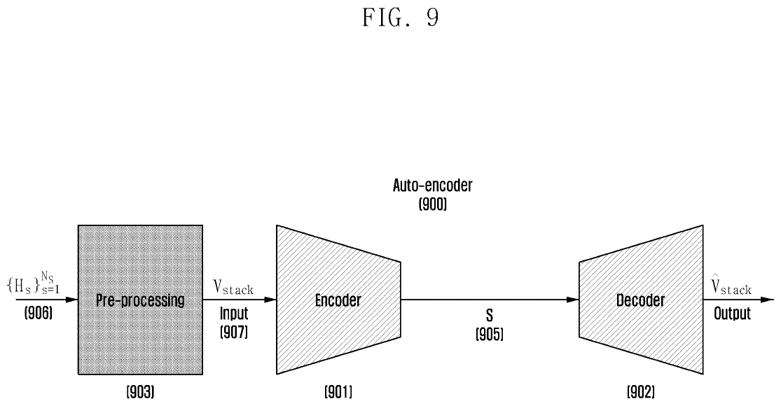

FIG. 9 illustrates an exemplary embodiment for an autoencoder based CSI feedback where a preprocessing unit transforms the estimated channel to stacked eigenvectors according to embodiments of the present disclosure. The input for an autoencoder 900 can take different formats. In one embodiment, the input can be the eigenvectors of the channel. The covariance matrix of an Nₜ×Nᵣ channel matrix H given as H^{H}H can be computed by the UE. Then, the dominant eigenvectors of the covariance matrix svd(H^{H}H)=VΣΛ given as V=[v₁ ⋅ ⋅ ⋅ vᵣ] can be considered as an input for the autoencoder. An exemplary illustration of such embodiment is given in FIG. 9. A set of Nₛ channel matrices which belong to Nₛ subbands, i.e.,

$${\{ {H}_{s} \}}_{s = 1}^{{N}_{s}} ,$$

is input 906 for a pre-processing unit 903. The preprocessing unit compute the Nₛ eigenvectors and stack them as a column of a matrix V_{stack}. An encoder 901 then generates a CSI feedback in terms of a bit stream s 905. The decoder 902 as part of the autoencoder takes the CSI feedback and reconstructs the stacked eigenvectors. Moreover, a gNB may use the reconstructed stacked eigenvectors \hat{V}_{stack} as precoders.

One consideration for further compression of the CSI reports is to take the time-domain correlation into account. In particular, the CSI reports in consecutive reporting occasions may have some correlations which can be exploited.

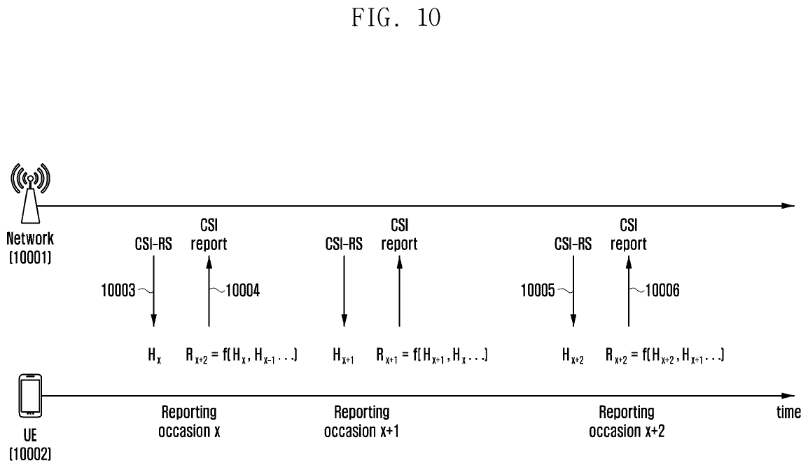

FIG. 10 illustrates an example CSI report that considers past CSI reports for construction of a reported CSI according to embodiments of the present disclosure. In one aspect of this disclosure, the UE considers the latest measurement of CSI-RS resources 10003, 10005 as well as the measurements corresponding to the past reporting occasions to construct the CSI report. An example is illustrated in FIG. 10. For reporting occasion x, the UE 10002 considers the channel corresponding to the latest measurement Hₓ as well as the channel measured for the past reporting occasions Hₓ₋ₙ for n=1,2, . . . . Thus, the CSI report 1004 for reporting occasion x can be modeled as Rₓ=f(Hₓ, Hₓ₋₁, . . . ). Upon reception of the CSI report for the reporting occasion x, the network may consider the past reporting occasions Rₓ₋₁, Rₓ₋₂, . . . to decode or interpret the Rₓ. Thus, the reconstructed CSI for reporting occasion x denoted by Ĥₓ can be represented as Ĥₓ=g(Rₓ, Rₓ₋₁, . . . ). Similarly, for reporting occasion x+1, the UE 10002 may consider the channel corresponding to measurement Hₓ₊₁ and the channel measured for the past reporting occasions Hₓ . . . . Thus, the CSI report for reporting occasion x+1 can be modeled as Rₓ₊₁=f(Hₓ₊₁, Hₓ, . . . ). For reporting occasion x+2, the UE 10002 may consider the channel corresponding to measurement Hₓ₊₂ and the channel measured for the past reporting occasions Hₓ . . . . Thus, the CSI report 1006 for reporting occasion x+2 can be modeled as Rₓ₊₂=f(Hₓ₊₂, Hₓ₊₁, . . . ).

One exemplary embodiment for the aforementioned CSI reporting mechanism is to apply an AI/ML model to learn the CSI construction function f(.) and CSI reconstruction function g(.).

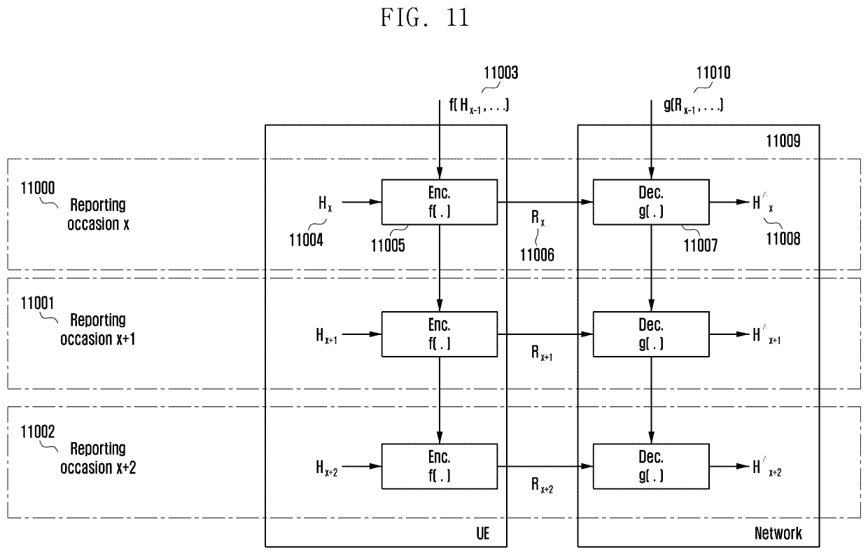

FIG. 11 illustrates an AI/ML-based CSI report mechanism that considers past CSI reports for construction of the reported CSI according to embodiments of the present disclosure. Exemplary implementation is illustrated in FIG. 11. At a reporting occasion x 11000, the UE takes the channel from the latest measurement Hₓ 11004 and the accumulated CSI from the past reporting occasions f(Hₓ₋₁, . . . ) as an input to its CSI generation model 11005. The CSI generation model 11005 constructs the reported CSI Rₓ for the reporting occasion x. Conversely, the CSI reconstruction model 11007 at the network 11009 (e.g., a gNB) takes the reported CSI feedback Rₓ as well as the reconstructed CSI from the past reporting occasion g(Rₓ₋₁, . . . ) 11010 and produces the corresponding reconstructed CSI Hₓ 11008. For reporting occasions x+1 11001 and x+2 11002, similar construction and reconstruction are performed.

In a yet another aspect of the disclosure, the UE may be configured by the network to apply preprocessing on the measured channel for reporting occasion x. The preprocessing may include projection to other domains, e.g., angle, delay, Doppler, using a predefined basis vectors. As an example, for a reporting occasion x, the UE may express a precoding matrix for a certain transmission layer as W_{gNB}=W₁W₂(W_{f})^{H} with spatial domain (SD) basis vectors W₁, frequency domain basis vectors W_{f} and linearly combining coefficients W₂. Conversely, the explicit channel matrix for the reporting occasion x can be represented as H=ΣₗλₗW_{UE,l}(W_{gNB,l})^{H} where λₗ, W_{UE,l} and W_{gNB,l} are the eigenvalue, the UE-side (left) and gNB-side (right) eigenvectors of the channel matrix H corresponding the layer l.

In one aspect of this disclosure, in Method I the network configures the UE to report the precoding information for reporting occasion x. The precoding information is reported in two components. The first component of the precoding information may include at least basis vectors information, e.g., SD and FD basis vectors. Moreover, the second component of the precoding information includes linearly combining coefficients with a CSI feedback generated by two-sided AI/ML model where the linear combining coefficients.

As a specific case of Method I, in Method I.1, the network may configure the UE to report the CSI feedback where the CSI feedback includes a precoding information that is reported in two components. The first component of the precoding information may include at least basis vectors information, e.g., SD and FD basis vectors, calculated from the channel matrix the UE measured from the latest CSI-RS resources before the reporting occasion x, e.g., W_{1,x-n} and W_{f,x-n} where n=0. Moreover, the second component of the precoding information includes linear combining coefficients with a CSI feedback generated by two-sided AI/ML model where the linear combining coeffients are calculated based on the channel measurement from the latest CSI-RS resources from the reporting occasion x.

As a specific case of Method I, in Method I.2, the network may configure the UE to report the CSI feedback where the CSI feedback includes a precoding information that is reported in two components. The first component of the precoding information may include at least basis vectors information, e.g., SD and FD basis vectors, calculated from the channel matrix the UE measured from the latest CSI-RS resource from a previous reporting occasion, x−n, e.g., W_{1,x-n} and W_{f,x-n} where n>0. Moreover, the second component of the precoding information includes linear combining coefficients with a CSI feedback generated by a two-sided AI/ML model where the linear combining coefficients are calculated based on the channel measurement from the latest CSI-RS resources from the reporting occasion x. The UE omits reporting the SD and FD basis vectors in the reporting occasion x.

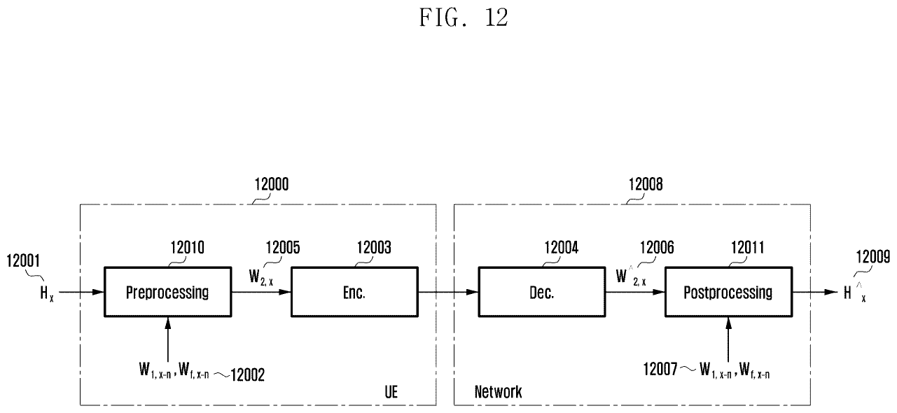

FIG. 12 illustrates an example AI/ML-based CSI report mechanism with preprocessing that considers the past CSI reports for construction of the reported CSI according to embodiments of the present disclosure. FIG. 12 illustrates exemplary implementation. In particular, the UE 12000 applies preprocessing 12010 on the UE's preferred precoding vectors 12001 by calculating the combining coefficients W_{2,x} 12005 for a given SD and FD basis vectors W_{1,x-n} and W_{f,x-n} 12002, respectively. Depending on the reporting occasion and W_{1,x-n} and W_{f,x-n} can be determined based on the latest CSI-RS resources from the reporting occasion x or previous reporting occasion x−n. The UE 12000 then inputs the combining coefficients 12005 to its CSI generation model 12003 that constructs the reported CSI for the reporting occasion x. The network 12008 applies the network-part (the CSI reconstruction model) 12004 of the two-sided model and produces the corresponding reconstructed CSI Ŵ_{2,x} 12006. The network 12008 then and applies postprocessing 12011 using the reported basis vectors W_{1,x-n} and W_{f,x-n} 12007 to generate a reconstructed preferred precoder Ĥₓ 12009.

In one aspect of this disclosure, the network may configure the UE with Method I with a periodic and/or semi-persistence CSI reporting. In particular, the network may configure the UE to report precoding information with two components where the first component includes the basis vector and/or the second component includes the linear combining coefficients where the information on the linear combining coefficients is generated by the UE-part of the two-sided AI/ML model. Moreover, the two components can be configured to be reported with different periodicity. As an example, the network may configure the reporting periodicity of the first component as integral multiple of the second component. As an example, the network configures a parameter N for the UE to report the first component with N times longer period than the second component, i.e., once in every N CSI reporting occasions of a certain configuration where the second component is reporting in each reporting occasion.

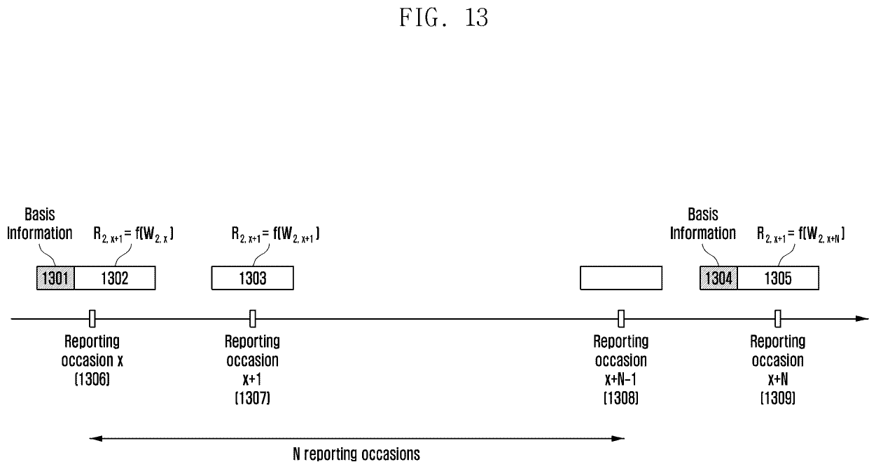

FIG. 13 illustrates an example periodic and semi-persistent AI/ML-based CSI report mechanism with preprocessing that considers past CSI reports for construction of a reported CSI according to embodiments of the present disclosure. As illustrated in FIG. 13, the second components 1302, 1303, 1308, 1309 are reported in the reporting occasions x, x+1, . . . , x+N−1, x+N and the first components 1301, 1304 are reported in the reporting occasions x and x+N, which means that the period for reporting the first component is N times longer than the period for reporting the second component.

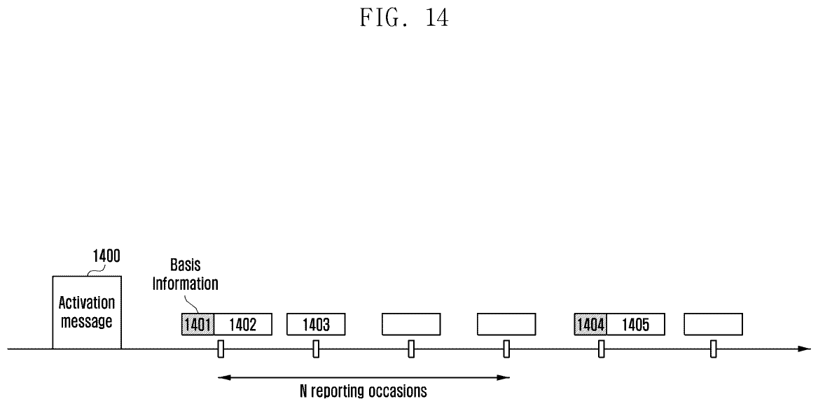

FIG. 14 illustrates an example semi-persistent AI/ML-based CSI report mechanism with preprocessing that considers the past CSI reports for construction of the reported CSI according to embodiments of the present disclosure.

In one aspect of this disclosure, when the network configures the UE with method I with periodic or semi-persistent CSI report, the UE is expected to report both the first and second components in the first CSI reporting occasion. The first CSI reporting occasion for periodic CSI report corresponds the earliest report after the UE receives the RRC configuration for the CSI report. The first CSI reporting occasion for semi-persistent CSI report corresponds the earliest report 1401 after the UE receives the activation message 1400 for the semi-persistent CSI report as illustrated in FIG. 14. As illustrated in FIG. 14, both the first and second components 1401, 1402 are reported on the first reporting occasion after the activation message 1400 is received. Further, both the first and second components 1404, 1405 are reported on the reporting occasions after N reporting occasions from the first reporting occasion, while the second components 1402, 1403, are reported on respective reporting occasions.

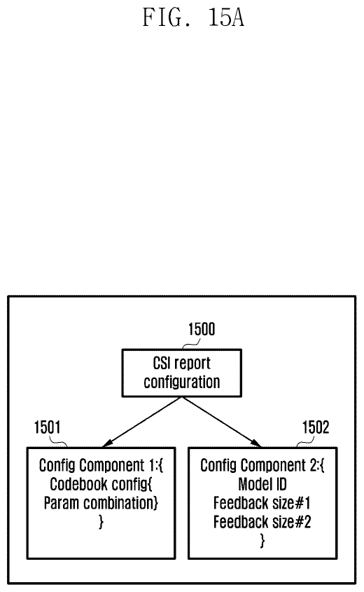

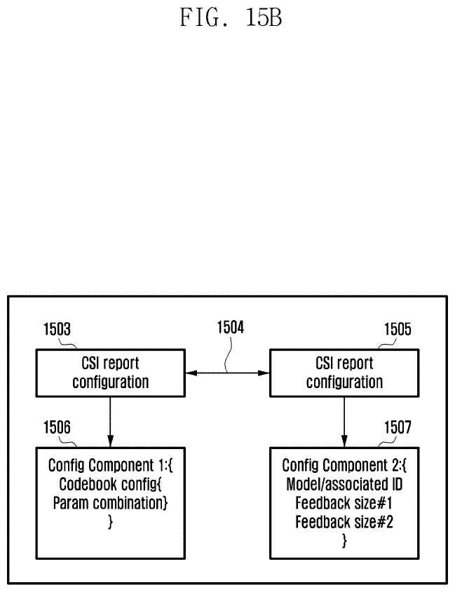

FIGS. 15A and 15B illustrate example report configuration mechanism for AI/ML-based CSI report mechanism with preprocessing that considers the past CSI reports for construction of the reported CSI according to embodiments of the present disclosure.

In one aspect of this disclosure, the CSI report configuration for Method I includes configuration aspects that are applied for the reporting of the first component and second component of the CSI report and configuration aspects common to both components. This is illustrated in FIG. 15A where a CSI reporting configuration 1500 includes configuration for component 1 (1501) and configuration for component 2 (1502). A yet another exemplary configuration illustrated in FIG. 15B is linking two CSI report configurations (1503 and 1505 where the two reporting configurations corresponds the configuration for component 1 (1506) and component 2 (1507).

In one aspect of this disclosure, the CSI report configuration includes codebook configuration for the first component of the CSI report. Conversely, the aspect of the CSI report configuration corresponding to the second component may include a mode/associated ID for two-sided model pairing, feedback sizes for the second component.

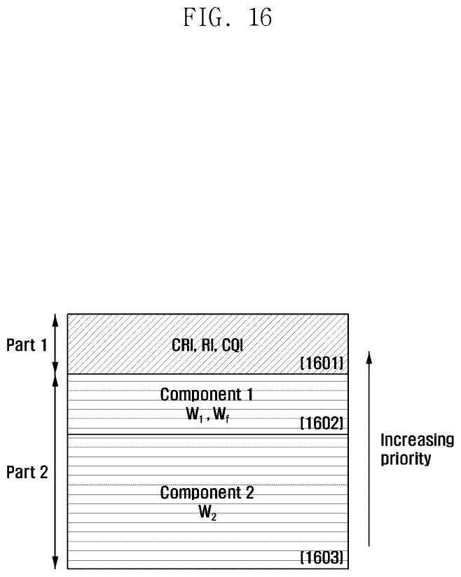

FIG. 16 illustrates example UCI construction aspects for an AI/ML-based CSI report mechanism with preprocessing that considers past CSI reports for construction of a reported CSI according to embodiments of the present disclosure.

As a yet another aspect of this disclosure, the network configures the UE with a CSI report corresponding to Method I where the UE constructs the UCI with two parts. The two parts as illustrated in FIG. 16 where the first part includes CRI, RI and CQI 1601, if reported, while the second part includes the precoding information reported in component 1 (1602) and component 2 (1603). The UE determines the priority levels for Part 1 and Part 2 CSI with decreasing order from information in part 1 and information in part 2. The UE further determines the priority levels for the contents of Part 2 CSI with component 1 having higher priority than contents of component 2.

When the UE applies Part I and/or Part II CSI dropping, it applies by starting from the lowest priority and in an increasing order of priority, i.e., a content with higher priority shall not be dropped while a content with lower priority is not dropped.

In one aspect of this disclosure, the network may configure the UE with Method I with aperiodic CSI reporting where a downlink control information (DCI) is received by the UE from the network to trigger one or more CSI reports corresponding to one or more reporting occasions in the time domain. In particular, the network may configure the UE to report precoding information including two components where the first component includes the basis vectors information and/or the second component includes the linearly combining coefficients where the information on the linear combining coefficients are generated by the UE-part of the two-sided AI/ML model. Upon the reception of a DCI triggering message from the network, the UE reports a CSI report for the first reporting occasion which includes both the first and second component. If more than one reporting occasion are triggered by the network, the UE reports the second component of the CSI report and omits the first component for the CSI report occasions other than the first one.

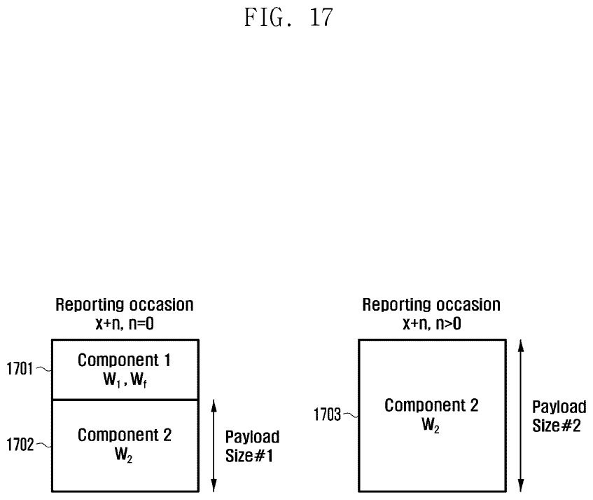

FIG. 17 illustrates example UCI construction aspects for the first CSI report and N−1 subsequent CSI reports in an AI/ML-based CSI report mechanism that spans N CSI reporting occasions according to embodiments of the present disclosure.

As another aspect of this disclosure, the network configures the UE with Method I where a UE is configured with two payload sizes payload size #1 and payload size #2. Up on receiving such configuration, the UE determines the size of the second component 1702, 1703 to be payload size #1 and payload size #2 for the CSI reporting occasion with and without the first component 1701, respectively, as illustrated in FIG. 17.

As a yet another aspect of this disclosure, the network configures the UE with a CSI report configuration for Method I where a UE is configured with a single payload size. Upon receiving such configuration, when the CSI reporting occasion of the same configuration includes the first component, the UE determines the size of the second component to be the configured payload size. When the CSI reporting occasion of the same configuration does not include the first component, the UE determines the size of the second component to be the size of configured payload size for the second component plus the corresponding size of the first component of the same CSI report configuration.

In Method I, the preferred rank by the UE may change during the period of the first CSI component, i.e., N reporting occasions for the second component. However, since the basis information in the first component is rank dependent, the UE may not be able to update the rank during this period. Thus, a restriction can be introduced. In the legacy CSI report, the UE may have to indicate the preferred analog beam, TRP, etc. by indicating the preferred CSI-RS resource with CSI-RS resource indicator (CRI).

In accordance to one aspect of this disclosure, when the UE reports the precoding information according to Method I.1, i.e., when the UE reports the precoding information in two components, where the first component is reported once for every N consecutive reporting occasions, each occasion contains the second component, and rank restriction among the N consecutive reporting occasions is considered. The restriction can be indicated by higher layer parameter. In particular, the UE may be restricted to report the CSI for the N reporting occasion to be for the same rank indicated by a rank indicator (RI), reported only in the first reporting occasion, i.e., the reporting occasion including the first component of the CSI report. The UE omits RI reporting for the subsequent N−1 reporting occasions.

In Method I, in order for the UE to report the basis vectors in the first component of precoding information report only once for every N consecutive CSI reporting occasions, the UE needs to be restricted to determine and report CSI associated with the same CSI-RS resource. Thus, CRI reporting restriction and update on the legacy CSI reporting is required.

In accordance to one aspect of this disclosure, when the UE reports the precoding information according to Method I.1, i.e., when the UE reports the precoding information in two components, where the first component is reported once for every N consecutive reporting occasions, each occasion contains the second component, and CRI reporting restriction among the N consecutive reporting occasions is considered. The restriction can be indicated by higher layer parameter. In particular, the UE may be restricted to report the CSI for the N reporting occasion to be for the same CRI reported only in the first reporting occasion, i.e., the reporting occasion including the first component of the CSI report. The UE omits CRI reporting for the subsequent N−1 reporting occasions.

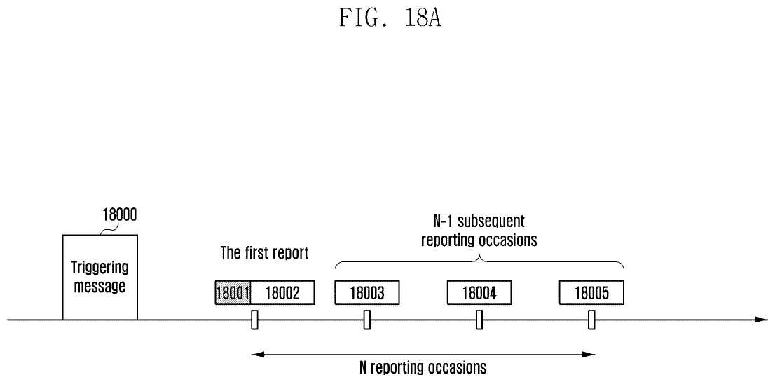

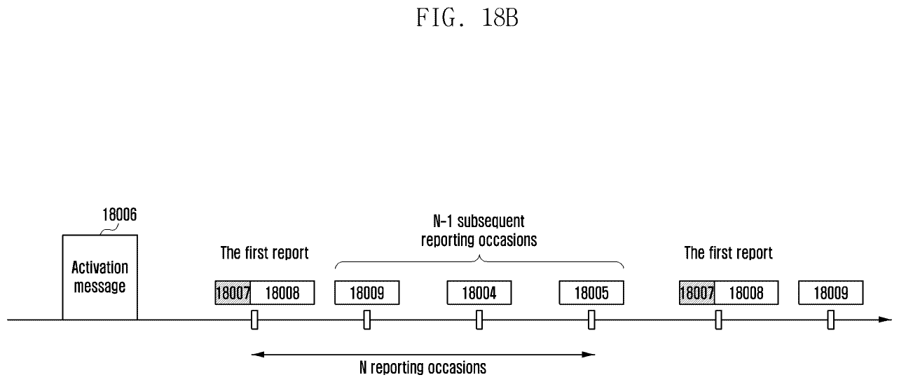

FIGS. 18A and 18B illustrate example aperiodic and semi-persistent reporting for AI/ML-based CSI report mechanism that spans N CSI reporting occasions according to embodiments of the present disclosure.

Exemplary embodiments of the above aspects of this disclosure are illustrated in FIGS. 18A and 18B. In FIG. 18A, for aperiodic reporting of a CSI report with Method 1, the earliest reporting occasion after the reception of the triggering downlink control information (DCI) 18000 is designated as the first reporting instances and may contain CRI, RI, CQI and both first 18001 and second part 18002 of the precoding information. In accordance to one aspect of this disclosure, the subsequent N−1 reports 18003, 18004, and 18005 may contain CQI, and second component of the precoding information. The UE omits reporting CRI, RI, and the first component of the precoding information for the subsequent N−1 reporting occasions of the CSI report. Similarly, for semi-persistent CSI report the designation of the first and subsequent N−1 reports is illustrated in FIG. 18B. FIG. 18B, for semi-persistent CSI report, the earliest reporting occasion after the reception of the activation message 18006 is designated as the first reporting instances and may contain CRI, RI, CQI and both first 18007 and second part 18008 of the precoding information. In accordance to one aspect of this disclosure, the subsequent N−1 reports 18009, 18004, and 18005 may contain CQI, and second component of the precoding information.

In some cases, it may be beneficial if the UE updates on the first part of the precoding information within the N associated CSI reporting occasions when the preferred rank assumption or associated CSI-RS resource, e.g., analog beam, TRP, etc. changes. This will allow dynamic rank or analog beam adaptation for higher performance.

In accordance to one aspect of this disclosure, when the UE reports the precoding information according to Method I.1, i.e., when the UE reports the precoding information in two components where the first component is reported once for every N consecutive reporting occasions, each reporting occasion contains the second component, and when the UE's preferred rank changes in the N−1 subsequent CSI reporting occasions as compared to the first reporting occasion, the UE may update the preferred rank as well as the first component of precoding information.
The network may configure the UE on whether rank adaptation within the N reporting occasions is possible via a higher layer signaling.
For the n-th reporting occasion among the subsequent N−1 CSI reporting occasions other than the first one, when the preferred rank changes from the latest reported rank, the UE updates, i.e., includes the corresponding rank-dependent contents of the first component in the n-th reporting occasions. As an example, the UE may update the FD-domain basis.
The UE reports the RI in all N CSI report occasions.
If two payload sizes are configured for the second component of the precoding information,
   for the CSI reporting occasions where the first component of the precoding information is also reported, the UE reports the second component with the first configured payload size.
   for the CSI reporting occasions where the first component of the precoding information is not reported, the UE reports the second component with the second configured payload size
If a single payload size is configured for the second component of the precoding information,
   for the CSI reporting occasions where the first component of the precoding information is also reported, the UE reports the second component with the configured payload size.
   for the CSI reporting occasions where the first component of the precoding information is not reported, the UE reports the second component by determining its size as the configured payload size plus the payload size for the first component.

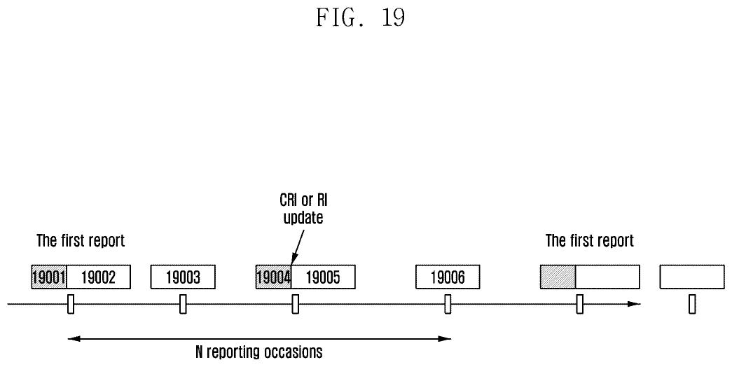

FIG. 19 illustrates an example CRI and RI adaptation for an AI/ML-based CSI report mechanism that spans N CSI reporting occasions according to embodiments of the present disclosure. In accordance to one aspect of this disclosure, when the UE reports the precoding information according to Method I.1, i.e., when the UE reports the precoding information in two components where the first component 19001 is reported once for every N consecutive reporting occasions, each occasion contains the second component 19002, 19003, 19005, 19006, and when the UE's preferred CRI changes in the N−1 subsequent CSI reporting occasions as compared to the first reporting occasion, the UE may update the preferred CRI as well as the first component of precoding information 19004, as illustrated in FIG. 19.
The network may configure the UE on whether CRI adaptation within the N reporting occasions is possible via a higher layer signaling.
For the n-th reporting occasion among the subsequent N−1 CSI reporting occasions other than the first one, when the preferred CRI changes from the latest reported CRI, the UE updates, i.e., includes the corresponding CRI-dependent contents of the first component in the n-th reporting occasions. As an example, the UE may update the SD and FD basis vectors.
The UE reports the CRI in all N CSI report occasions.
If two payload sizes are configured for the second component of the precoding information,
   for the CSI reporting occasions where the first component of the precoding information is also reported, the UE reports the second component with the first configured payload size.
   for the CSI reporting occasions where the first component of the precoding information is not reported, the UE reports the second component with the second configured payload size
If a single payload size is configured for the second component of the precoding information,
   for the CSI reporting occasions where the first component of the precoding information is also reported, the UE reports the second component with the configured payload size.
   for the CSI reporting occasions where the first component of the precoding information is not reported, the UE reports the second component by determining its size as the configured payload size plus the payload size for the first component.

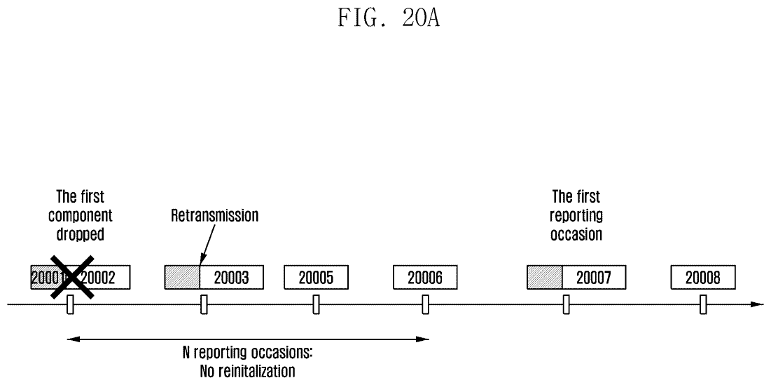

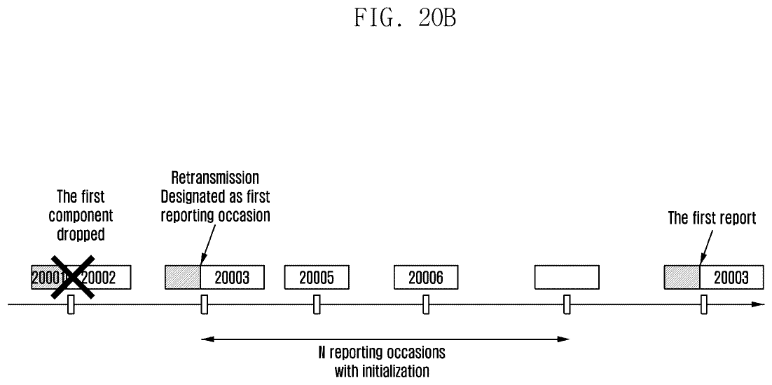

FIGS. 20A and 20B illustrate example retransmission aspects for an AI/ML-based CSI report mechanism that spans N CSI reporting occasions according to embodiments of the present disclosure. In some cases, when the UE is configured with Method I, one or both of the components for precoding information may be dropped 20001, 20002. If the UE drops the first component for the first CSI reporting 20001, 20002, the network may not be able to reconstruct the preferred precoder for the subsequent N−1 CSI report occasions which do not include the first component. To alleviate this problem the UE may have to retransmit the first component in the immediately following CSI report occasion and rest the reporting cycle as illustrated in (FIGS. 20A and 20B.

In accordance to one aspect of this disclosure, when the UE reports the precoding information according to Method I.1, i.e., when the UE is configured to report the precoding information in two components where the first component is reported once for every N consecutive reporting occasions 20003, 20005, 20006, where each occasion contains the second component, and when the UE drop part or the whole content of the first component for the first CSI reporting occasion 20001, 20002
The UE reports the first component of the precoding information in the immediately following CSI report occasion 20003,
   The earliest CSI report that carries the first component after the dropping is designated as the first CSI reporting occasion as illustrated in FIG. 20B
      For periodic and semi-persistent CSI report, the reporting cycle is reinitialized, i.e., the earliest CSI reporting occasion, after the newly designated CSI reporting occasion as the first report, is the one after N CSI reporting occasions in the time domain.

In case N reporting occasions are not reinitialized, the next first reporting occasion is not changed and the first report is reported on the first reporting occasion 20007, 20008.

In case N reporting occasions are initialized, the next first reporting occasion is changed and the first report is reported on the changed first reporting occasion 20003.

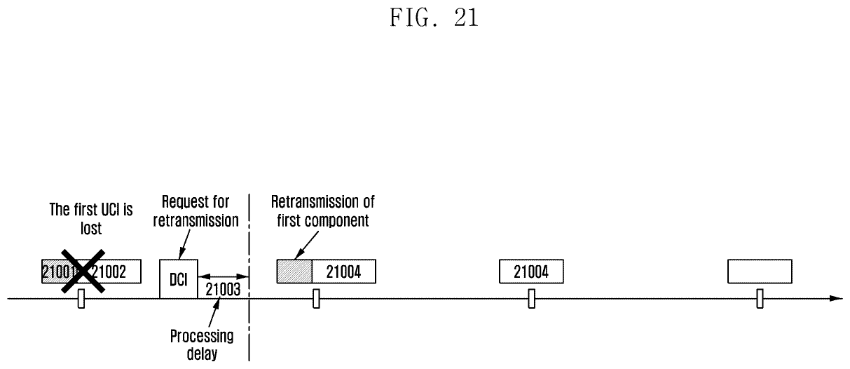

FIG. 21 illustrates example retransmission DCI and timeline aspects for an AI/ML-based CSI report mechanism that spans N CSI reporting occasions according to embodiments of the present disclosure.

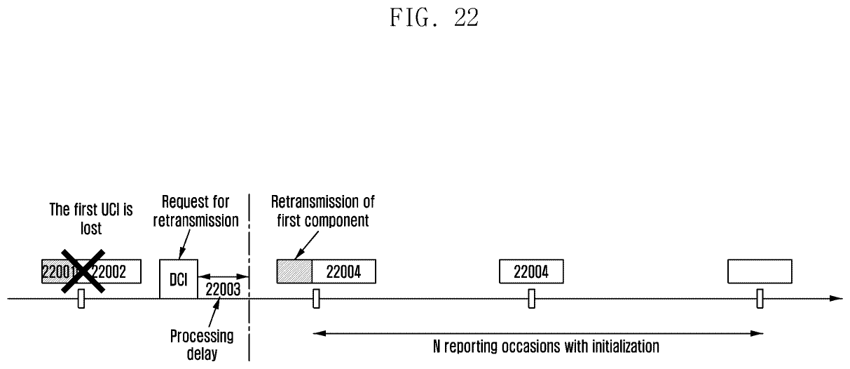

FIG. 22 illustrates example retransmission DCI, timeline and re-initialization aspects for AI/ML-based CSI report mechanism that spans N CSI reporting occasions. according to embodiments of the present disclosure.

In some cases, as illustrated in FIG. 21, and FIG. 22, when the UE is configured with Method I, the UCI carrying the CSI report might be lost. In the case the CSI report that carries component 1 is lost 21001, 21002, 22001, 22002, the network may fail to reconstruct the preferred precoder for the first and subsequent N−1 CSI report occasions that do not include the first component 21004, 22004. To alleviate this problem the UE may have to retransmit the first component in the immediately following CSI repot occasion after receiving indication from the network for the retransmission.

In accordance to one aspect of this disclosure, when the UE reports the precoding information according to Method I.1, i.e., when the UE is configured to report the precoding information in two components where the first component is reported once for every N consecutive reporting occasions and each occasion contains the second component, the network may indicate to the UE through a DCI on the retransmission of the first component of the CSI report.
Upon the reception of DCI, the UE retransmits the first component of the precoding information in the earliest occasion of the CSI report after a predefined DCI processing time 21003, 22003.
   The earliest CSI report that carries the first component after the DCI that indicates the retransmission is designated as the first CSI reporting occasion.
      For periodic and semi-persistent CSI report, the reporting cycle is reinitialized, i.e., the earliest CSI reporting occasion, after the newly designated CSI reporting occasion as the first report, is the one after N CSI reporting occasions in the time domain.

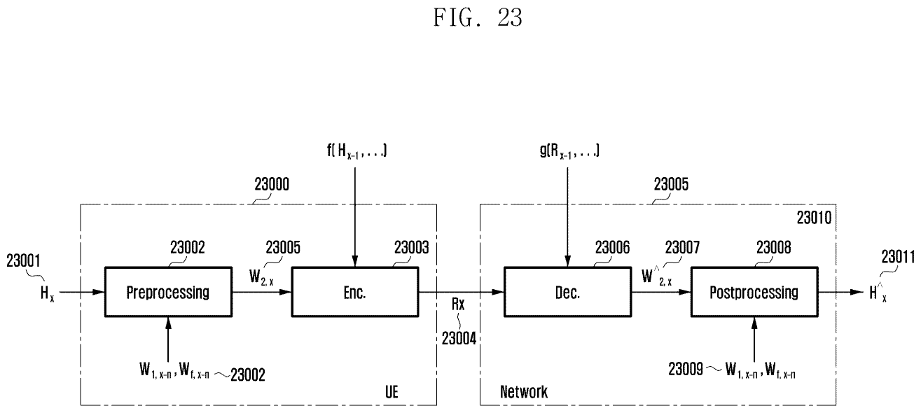

FIG. 23 illustrates an example interdependent AI/ML-based CSI report mechanism according to embodiments of the present disclosure. In one aspect of this disclosure, the UE considers the latest measurement of CSI-RS resources as well as the measurements corresponding to the past reporting occasions to construct the CSI report. An example is illustrated in FIG. 23. For reporting occasion x, the UE considers the channel corresponding to the latest measurement Hₓ 23001 as well as the channel measured for the past reporting occasions Hₓ₋ₙ 23000 for n=1,2, . . . . Thus, the CSI report for reporting occasion x, can be modeled as Rₓ=f(Hₓ, Hₓ₋₁, . . . ). Upon reception of the CSI report for the reporting occasion x, the network may consider the past reporting occasions Rₓ₋₁, Rₓ₋₂, . . . to decode 23006 or interpret the Rₓ. Thus, the reconstructed CSI 23011 for reporting occasion x denoted by Ĥₓ can be represented as Ĥₓ=g(Rₓ, Rₓ₋₁, . . . ).

Another exemplary embodiment of this disclosure is depicted in FIG. 23. The UE up on the configuration by the network, the UE may apply preprocessing 23002 on the measured channel for reporting occasion x. The preprocessing may include projection to other domains such as angle, delay, or Doppler, using a predefined basis vectors. As an example, for a reporting occasion x, the UE may express a precoding matrix for a certain transmission layer as W_{gNB}=W₁W₂(W_{f})^{H} with spatial domain (SD) basis vectors W₁, frequency domain basis vectors W_{f} and linearly combining coefficients W₂. At a reporting occasion x, the UE takes the preprocessed information, e.g., the linear combining coefficients W₂ based on the channel from the latest measurement Hₓ 23001 and the accumulated CSI from the past reporting occasions f(Hₓ₋₁, . . . ) 23000 as an input to its CSI generation model 23003. The CSI generation model 2300) constructs the reported CSI Rₓ 23004 for the reporting occasion x. Conversely, the CSI reconstruction model 23006 takes the reported CSI feedback Rₓ as well as the reconstructed CSI from the past reporting occasion g(Rₓ₋₁, . . . ) 23005 and produces the corresponding reconstructed CSI W_{2,x} 23007. Finally, the network reconstructs the channel/precoding information Ĥₓ 23011 with a post-processing block (23008 and by using a basis vectors 23009.

In one aspect of this disclosure, in Method II the network configures the UE to report the precoding information for reporting occasion x. The precoding information includes a CSI feedback generated by a two-sided AI/ML model where the CSI feedback calculated from the channel matrix the UE measured from the latest CSI-RS resource from the report Hₓ and a previously reporting occasion, Hₓ₋ₙ where n>0.

As a specific case of Method II, in Method II.1, the network may configure the UE to report the CSI feedback where the CSI feedback includes a precoding information that is reported in two components. The first component of the precoding information may include at least basis vectors information, e.g., SD and FD basis vectors, calculated from the channel matrix that the UE measured from the latest CSI-RS resource from a previous reporting occasion, x−n, e.g., W_{1,x-n} and W_{f,x-n} where n>0. Moreover, the second component of the precoding information includes a CSI feedback generated by the two-sided AI/ML model, where the CSI feedback is calculated from the channel matrix that the UE measured from the latest CSI-RS resource from the report Wy and linearly combining matrices from previously reporting occasions, f(Wₓ₋ₙ . . . ) where n>0.

As a specific case of Method II.1, the network configures the UE to report the first and second components of the precoding information in different periodicities. As an example, the network may configure the UE with a higher layer parameter N which indicates to the UE that it reports the first component of the precoding information in every other N consecutive CSI reporting occasions.

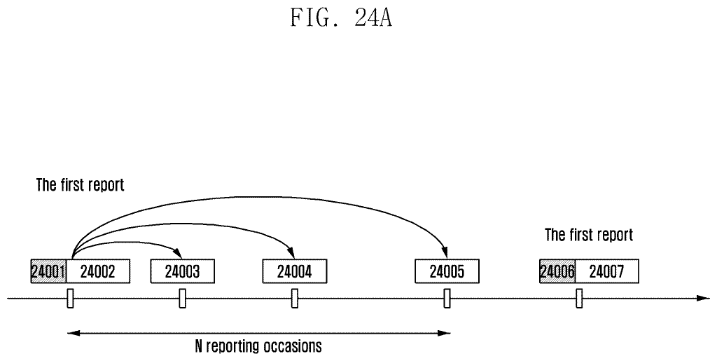

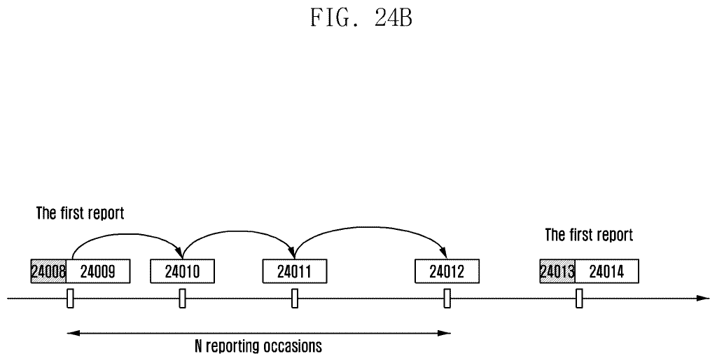

FIGS. 24A and 24B illustrate an example interdependent AI/ML-based CSI report mechanism with preprocessing that spans N CSI reporting occasions according to embodiments of the present disclosure. Exemplary embodiment of Method II.1 is illustrated in FIGS. 24A and 24B. As illustrated in FIGS. 24A and 24B, the second components 24002, 24003, 24004, 24005, 24007, 24009, 24010, 24011, 24012 are reported in the corresponding reporting occasions and the first components (24001, 24006, 24008, 24013 are reported in the corresponding occasions, which means that the period for reporting the first component is N times longer than the period for reporting the second component. In FIG. 24A, the UE reports the first component and the second component in the first CSI report occasion 24002 and 24003.
For the CSI reporting occasion other than the first one, i.e., the CSI reporting occasions which does not include the first component of the precoding information, the UE constructs the reported second component of the CSI report from the channel measurement on latest CSI-RS resources and the component of the precoding information reported in the first CSI reporting occasion.
For the first CSI reporting occasion, i.e., the CSI reporting occasion that includes the first component of the precoding information, the UE constructs the reported second component of the CSI report from the channel measurement on latest CSI-RS resources.

In accordance to one aspect of this disclosure, when the UE reports the precoding information according to Method II, i.e., the precoding information includes a CSI feedback generated by a two-sided AI/ML model, where the CSI feedback is calculated from the channel matrix that the UE measured from the latest CSI-RS resource from the report Hₓ and a previously reporting occasion, Hₓ₋ₙ where n>0, and the network may indicate to the UE through a DCI on the retransmission of the of a CSI report corresponding to the past measurement occasion Hₓ₋ₙ where n>0.
Upon the reception of a DCI, the UE retransmits of a CSI report corresponding to the past measurement occasion Hₓ₋ₙ where n>0 in the earliest occasion of the CSI report after a predefined DCI processing time.
In accordance to the above aspects of this disclosure, a CSI report corresponding to the past measurement occasion Hₓ₋ₙ may correspond to the first component, the second component or both.
In accordance to the above aspects of this disclosure, a CSI report corresponding to the past measurement occasion Hₓ₋ₙ may correspond to a single component
In accordance to the above aspects of this disclosure, a CSI report corresponding to the past measurement occasion Hₓ₋ₙ may correspond to the first reporting occasion as illustrated in FIG. 24A or the latest past reporting occasion as illustrated in FIG. 24B.

Although the present disclosure has been described with various embodiments, various changes and modifications may be suggested to one skilled in the art. It is intended that the present disclosure encompass such changes and modifications as fall within the scope of the appended claims.

What is claimed is:

1. A user equipment (UE) in a communication system, the UE comprising:
a transceiver; and
a processor coupled with the transceiver and configured to:
receive, from a base station, configuration information associated with channel state information (CSI) report;
identify, based on the configuration information, that a first precoding matrix indicator (PMI) component on basis information and N second PMI components on combining coefficients are to be transmitted for the CSI report; and
transmit, to the base station, the first PMI component and the N second PMI components,
wherein the first PMI component is transmitted in a first CSI reporting occasion among N CSI reporting occasions, and
wherein the N second PMI components are transmitted in the N CSI reporting occasions.

2. The UE of claim 1, wherein in case that the CSI report is configured with periodic or semi-persistent, the first PMI component is transmitted according to a first reporting periodicity and the N second PMI components are transmitted according to a second reporting periodicity,
wherein the first reporting periodicity is N times of the second reporting periodicity,
wherein the second reporting periodicity corresponds to the N CSI reporting occasions,
wherein the configuration information includes at least one of:
information on the first reporting periodicity;
information on the second reporting periodicity; or
information on a value of N, and
wherein in case that the CSI report is configured with aperiodic, the N CSI reporting occasions are identified based on first downlink control information (DCI) triggering the CSI report configured with aperiodic.

3. The UE of claim 1, wherein a second PMI component transmitted in a CSI reporting occasion is calculated based on the first PMI component and a second PMI component transmitted in a past CSI reporting occasion.

4. The UE of claim 1, wherein the first PMI component, a second PMI component, a CSI reference signal (CSI-RS) resource indicator (CRI) and a rank indicator (RI) for the CSI report are transmitted in the first CSI reporting occasion,
wherein N−1 second PMI components are transmitted in N−1 CSI reporting occasions which are remaining CSI reporting occasions except for the first CSI reporting occasion, and
wherein in case that at least one of CRI adaptation or RI adaptation is allowed in the N CSI reporting occasions based on the configuration information, at least one of updated CRI or updated RI is transmitted in at least one of the remaining CSI reporting occasions.

5. The UE of claim 1, wherein in case that transmission of the first PMI component in the first CSI reporting occasion is dropped at least partially:
the first PMI component is retransmitted in an immediately following CSI reporting occasion;
a second PMI component is transmitted in the immediately following CSI report occasion in which the first PMI component is retransmitted; and
the N CSI reporting occasions are initialized such that a first CSI reporting occasion among the initialized N CSI reporting occasions corresponds to the immediately following CSI report occasion in which the first PMI component is retransmitted.

6. The UE of claim 1, wherein in case that second DCI indicating retransmission of the first PMI component is received from the base station:
the first PMI component is retransmitted in an earliest CSI reporting occasion after a processing delay for the second DCI and after reception of the second DCI;
a second PMI component is transmitted in the earliest CSI reporting occasion in which the first PMI component is retransmitted; and
the N CSI reporting occasions are initialized such that a first CSI reporting occasion among the initialized N CSI reporting occasions corresponds to the earliest CSI reporting occasion in which the first PMI component is retransmitted.

7. A method performed by a user equipment (UE) in a communication system, the method comprising:
receiving, from a base station, configuration information associated with channel state information (CSI) report;
identifying, based on the configuration information, that a first precoding matrix indicator (PMI) component on basis information and N second PMI components on combining coefficients are to be transmitted for the CSI report; and
transmitting, to the base station, the first PMI component and the N second PMI components,
wherein the first PMI component is transmitted in a first CSI reporting occasion among N CSI reporting occasions, and
wherein the N second PMI components are transmitted in the N CSI reporting occasions.

8. The method of claim 7, wherein in case that the CSI report is configured with periodic or semi-persistent, the first PMI component is transmitted according to a first reporting periodicity and the N second PMI components are transmitted according to a second reporting periodicity,
wherein the first reporting periodicity is N times of the second reporting periodicity,
wherein the second reporting periodicity corresponds to the N CSI reporting occasions,
wherein the configuration information includes at least one of:
information on the first reporting periodicity;
information on the second reporting periodicity; or
information on a value of N, and
wherein in case that the CSI report is configured with aperiodic, the N CSI reporting occasions are identified based on first downlink control information (DCI) triggering the CSI report configured with aperiodic.

9. The method of claim 7, wherein a second PMI component transmitted in a CSI reporting occasion is calculated based on the first PMI component and a second PMI component transmitted in a past CSI reporting occasion.

10. The method of claim 7, wherein the first PMI component, a second PMI component, a CSI reference signal (CSI-RS) resource indicator (CRI) and a rank indicator (RI) for the CSI report are transmitted in the first CSI reporting occasion,
wherein N−1 second PMI components are transmitted in N−1 CSI reporting occasions which are remaining CSI reporting occasions except for the first CSI reporting occasion, and
wherein in case that at least one of CRI adaptation or RI adaptation is allowed in the N CSI reporting occasions based on the configuration information, at least one of updated CRI or updated RI is transmitted in at least one of the remaining CSI reporting occasions.

11. The method of claim 7, wherein in case that transmission of the first PMI component in the first CSI reporting occasion is dropped at least partially:
the first PMI component is retransmitted in an immediately following CSI reporting occasion;
a second PMI component is transmitted in the immediately following CSI report occasion in which the first PMI component is retransmitted; and
the N CSI reporting occasions are initialized such that a first CSI reporting occasion among the initialized N CSI reporting occasions corresponds to the immediately following CSI report occasion in which the first PMI component is retransmitted.

12. The method of claim 7, wherein in case that second DCI indicating retransmission of the first PMI component is received from the base station:
the first PMI component is retransmitted in an earliest CSI reporting occasion after a processing delay for the second DCI and after reception of the second DCI;
a second PMI component is transmitted in the earliest CSI reporting occasion in which the first PMI component is retransmitted; and
the N CSI reporting occasions are initialized such that a first CSI reporting occasion among the initialized N CSI reporting occasions corresponds to the earliest CSI reporting occasion in which the first PMI component is retransmitted.

13. A base station in a communication system, the base station comprising:
a transceiver; and
a processor coupled with the transceiver and configured to:
transmit, to a user equipment (UE), configuration information associated with channel state information (CSI) report, wherein the configuration information is associated with the UE to transmit a first precoding matrix indicator (PMI) component on basis information and N second PMI components on combining coefficients for the CSI report; and
receive, from the UE, the first PMI component and the N second PMI components, wherein the first PMI component is received in a first CSI reporting occasion among N CSI reporting occasions, and
wherein the N second PMI components are received in the N CSI reporting occasions.

14. The base station of claim 13, wherein in case that the CSI report is configured with periodic or semi-persistent, the first PMI component is received according to a first reporting periodicity and the N second PMI components are received according to a second reporting periodicity,
wherein the first reporting periodicity is N times of the second reporting periodicity,
wherein the second reporting periodicity corresponds to the N CSI reporting occasions,
wherein the first configuration information includes at least one of:
information on the first reporting periodicity;
information on the second reporting periodicity; or
information on a value of N, and
wherein in case that the CSI report is configured with aperiodic, the N CSI reporting occasions are indicated based on first downlink control information (DCI) triggering the CSI report configured with aperiodic.

15. The base station of claim 13, wherein a second PMI component received in a CSI reporting occasion is calculated based on the first PMI component and a second PMI component received in a past CSI reporting occasion.

16. The base station of claim 13, wherein the first PMI component, a second PMI component, a CSI reference signal (CSI-RS) resource indicator (CRI) and a rank indicator (RI) for the CSI report are received in the first CSI reporting occasion,
wherein N−1 second PMI components are received in N−1 CSI reporting occasions which are remaining CSI reporting occasions except for the first CSI reporting occasion, and
wherein in case that at least one of CRI adaptation or RI adaptation is allowed for the UE in the N CSI reporting occasions based on the configuration information, at least one of updated CRI or updated RI is received in at least one of the remaining CSI reporting occasions.

17. A method performed by a base station in a communication system, the method comprising:
transmitting, to a user equipment (UE), configuration information associated with channel state information (CSI) report, wherein the configuration information is associated with the UE to transmit a first precoding matrix indicator (PMI) component on basis information and N second PMI components on combining coefficients for the CSI report; and
receiving, from the UE, the first PMI component and the N second PMI components,
wherein the first PMI component is received in a first CSI reporting occasion among N CSI reporting occasions, and
wherein the N second PMI components are received in the N CSI reporting occasions.

18. The method of claim 17, wherein in case that the CSI report is configured with periodic or semi-persistent, the first PMI component is received according to a first reporting periodicity and the N second PMI components are received according to a second reporting periodicity,
wherein the first reporting periodicity is N times of the second reporting periodicity,
wherein the second reporting periodicity corresponds to the N CSI reporting occasions,
wherein the first configuration information includes at least one of:
information on the first reporting periodicity;
information on the second reporting periodicity; or
information on a value of N, and
wherein in case that the CSI report is configured with aperiodic, the N CSI reporting occasions are indicated based on first downlink control information (DCI) triggering the CSI report configured with aperiodic.

19. The method of claim 17, wherein a second PMI component received in a CSI reporting occasion is calculated based on the first PMI component and a second PMI component received in a past CSI reporting occasion.

20. The method of claim 17, wherein the first PMI component, a second PMI component, a CSI reference signal (CSI-RS) resource indicator (CRI) and a rank indicator (RI) for the CSI report are received in the first CSI reporting occasion,
wherein N−1 second PMI components are received in N−1 CSI reporting occasions which are remaining CSI reporting occasions except for the first CSI reporting occasion, and
wherein in case that at least one of CRI adaptation or RI adaptation is allowed for the UE in the N CSI reporting occasions based on the configuration information, at least one of updated CRI or updated RI is received in at least one of the remaining CSI reporting occasions.
